(19) United States
(12) Patent Application Publication
(10) Pub. No.: US 2019/0030657 A1
(43) Pub. Date: Jan. 31, 2019

(54) METHOD FOR DEPOSITING A DESIRED SUPERALLOY COMPOSITION

(71) Applicant: Siemens Energy, Inc., Orlando, FL (US)

(72) Inventor: Gerald J. Bruck, Pigeon Forge, TN (US)

(21) Appl. No.: 15/658,714

(22) Filed: Jul. 25, 2017

(51) Int. Cl. B23K 35/40; B23K 9/04; B23K 35/30

(52) U.S. Cl. CPC B23K 35/404; B23K 9/04; B23K 2201/001; B23K 35/3046; B23K 35/3033

(57) ABSTRACT

Processes for depositing a desired superalloy composition are provided. An elongated core member (20), such as made up of a wrought nickel-base alloy or a wrought cobalt-base alloy, may be drawn in connection with a wire drawing process. Elongated core member (20) includes at least one strengthening constituent having a reduced concentration to provide a desired level of ductility appropriate for the drawing of elongated core member (20). A coating (22) is applied to elongated core member (20). Coating (22) is configured to introduce a sufficient concentration of the strengthening constituent to form the desired superalloy composition when the coating and the elongated core member are melted together. This melting may occur during a welding process conducive to depositing the desired superalloy composition. The welding process may be performed in the context of repairing, rebuilding, and manufacturing superalloy components, such as for a gas turbine engine.

### BACKGROUND

### 1. Field

Disclosed embodiments are generally related to methods involving superalloy compositions that may be pre-formed as wires or other forms suitable for welding, and, more particularly, to methods conducive to achieving a level of ductility appropriate for performing a wire drawing process in connection with manufacturing of superalloy welding wire.

### 2. Description of the Related Art

Superalloy welding wire may be used in connection with various welding processes to repair, rebuild, and manufacture components intended to operate at high temperatures, such as components used in gas turbine engines. Presently, performing a wire drawing process in connection with superalloy weld wires is substantially burdensome and costly because superalloys are inherently strong and therefore difficult to draw into wire form. That is, the high superalloy strength and low superalloy ductility involved make superalloy weld wires hard to deform with low workability, and, for example, difficult to form into small diameter wires. Accordingly, there exists a need for a new and improved methodology for manufacturing superalloy welding wires.

### BRIEF DESCRIPTION

One embodiment described herein is a method for depositing a desired superalloy composition, as may be used in connection with welding processes involving superalloy welding wire. The method includes drawing an elongated core member comprising a wrought nickel-base alloy or a wrought cobalt-base alloy. The elongated core member includes a strengthening constituent having a reduced concentration to provide a desired level of ductility appropriate for the drawing of the elongated core member.

In accordance with a further disclosed embodiment, a method for depositing a desired superalloy composition includes melting a welding material during a welding process conducive to depositing the desired superalloy composition. The welding material is formed by an elongated core member comprising a wrought nickel base alloy or a wrought cobalt base alloy. The elongated core member includes at least one strengthening constituent having a reduced concentration and thus providing an increased level of ductility to the elongated core member. A coating on the elongated core is configured to introduce a sufficient concentration of the strengthening constituent to form the desired superalloy composition upon the melting of the coating and the elongated core member that form the welding material

### BRIEF DESCRIPTION OF THE DRAWINGS

FIG. 1 is a flow chart of a disclosed method for depositing a desired superalloy composition, such as may be used in connection with welding processes involving superalloy welding wire.

FIGS. 2-4 collectively show a flow sequence in connection with the disclosed method for depositing a desired superalloy composition.

### DETAILED DESCRIPTION

The inventor of the present invention has recognized that a practical limitation involving superalloys arises when a wire drawing process needs to be performed in connection with manufacturing of superalloy welding wire, such as for reducing the cross-section of the superalloy wire. As noted above, performing a wire drawing process in connection with a superalloy wire can be substantially burdensome and costly because of the high superalloy strength and the low superalloy ductility involved. As will be appreciated by those skilled in the art, and without wishing to be bound by existing theories, such strengthening properties are largely provided by a gamma prime precipitation in the microstructure of the superalloy

In view of such recognition, the present inventor proposes an innovative methodology in connection with superalloy wire manufacturing, as may involve an elongated core member, which, as will be described in greater detail below, is configured with a reduced concentration of a strengthening constituent to provide an increased level of ductility appropriate for performing a drawing process in connection with the elongated core member. As will be appreciated by the artisan, ductility is the ability of metals and alloys to be drawn, stretched or otherwise formed without breaking.

As used herein the expression “elongated core member” may involve various forms suitable for welding, such as wires, strips, rods, etc. Accordingly, although throughout this disclosure, expressions such as “wire drawing process” or “superalloy wire” may be used, it will be appreciated that such expressions should not be construed in a limited sense since disclosed methods are not limited to a wire form, since as noted above, other forms, such as strips, rods, etc., can equally benefit from disclosed methods.

Before, during or upon completion of the drawing process, the elongated core member, (which may be conceptually analogized as a precursor for making the superalloy welding wire) may be coated with a coating configured to introduce a sufficient concentration of the strengthening constituent to form the desired superalloy composition when the coating and the elongated core member are melted together, such as to form a weld pool in a weld prior to solidification. That is, the coating is configured to introduce a sufficient concentration of the strengthening constituent to restore the high superalloy strength and the low superalloy ductility normally associated with the desired superalloy composition.

Without limitation, disclosed embodiments may be useful for cost-effective manufacturing of welding materials, as may be used in welding processes for depositing the desired superalloy composition. Non-limiting examples of welding materials may be a superalloy weld filler material, or a consumable electrode. One non-limiting application may be for welding superalloy components, such as superalloy blades and vanes in a gas turbine engine. This welding may be performed in the context of repairing, rebuilding, and manufacturing such components.

In the following detailed description, various specific details are set forth in order to provide a thorough understanding of such embodiments. However, those skilled in the art will understand that embodiments of the present invention may be practiced without these specific details, that the present invention is not limited to the depicted embodiments, and that the present invention may be practiced in a variety of alternative embodiments. In other instances, methods, procedures, and components, which would be well-understood by one skilled in the art have not been described in detail to avoid unnecessary and burdensome explanation.

Furthermore, various operations may be described as multiple discrete steps performed in a manner that is helpful for understanding embodiments of the present invention. However, the order of description should not be construed as to imply that these operations need be performed in the order they are presented, nor that they are even order dependent, unless otherwise indicated. Moreover, repeated usage of the phrase “in one embodiment” does not necessarily refer to the same embodiment, although it may. It is noted that disclosed embodiments need not be construed as mutually exclusive embodiments, since aspects of such disclosed embodiments may be appropriately combined by one skilled in the art depending on the needs of a given application.

The terms “comprising”, “including”, “having”, and the like, as used in the present application, are intended to be synonymous unless otherwise indicated. Lastly, as used herein, the phrases “configured to” or “arranged to” embrace the concept that the feature preceding the phrases “configured to” or “arranged to” is intentionally and specifically designed or made to act or function in a specific way and should not be construed to mean that the feature just has a capability or suitability to act or function in the specified way, unless so indicated.

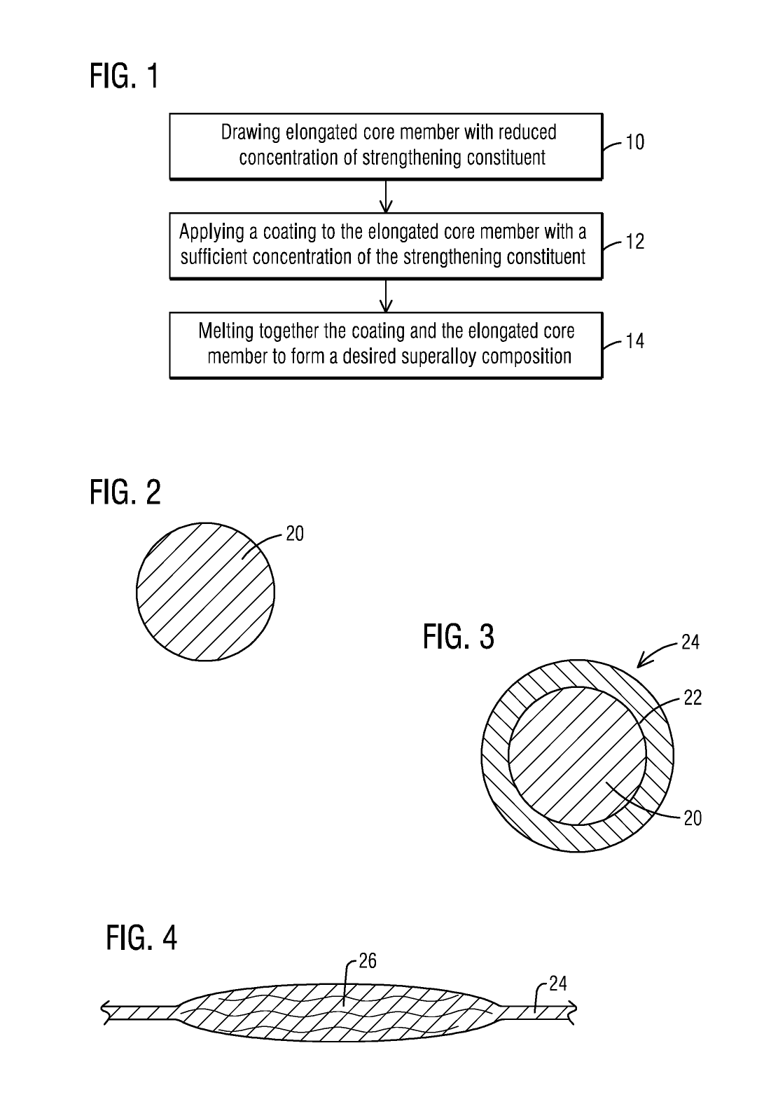

FIG. 1 is a flow chart of a disclosed method for depositing a desired superalloy composition, such as may be used in connection with welding processes involving a superalloy welding wire. FIGS. 2-4 collectively illustrate a flow sequence in connection with the disclosed method for depositing the desired superalloy composition. The description below makes reference both to the flow chart and to the flow sequence and to facilitate the reader tracking reference numerals in such figures, it is noted that the reference numerals in the flow chart start with the number 10 while the reference numbers in the flow sequence start with the number 20.

In one non-limiting example, step 10 allows drawing an elongated core member 20, such as may comprise without limitation a wrought nickel-base alloy or a wrought cobalt-base alloy. Elongated core member 20 may include at least one strengthening constituent having a reduced concentration to provide a desired level of ductility appropriate for the drawing of the elongated core member.

In one non-limiting example, the reduced concentration of the strengthening constituent in the elongated core member may be in range from approximately zero percent by weight to approximately two percent by weight relative to a total weight of the elongated core member. In one non-limiting embodiment, the desired level of ductility of the elongated core member may be in a range from approximately 10 percent elongation to approximately 45% elongation

In one non-limiting example, the strengthening constituent may be a gamma prime constituent. As will be appreciated by those skilled in the art, gamma prime is a primary strengthening phase for strengthening the alloy. In the case of a nickel-base superalloy, Ni₃(Al,Ti) commonly constitutes the gamma prime strengthening phase. Thus, in this case, aluminum or titanium may be non-limiting examples of gamma prime constituents that may be used with the reduced concentration to provide the desired level of ductility appropriate for the drawing of the elongated core member.

In the case of a cobalt-base superalloy, Co₃(Al,W) may constitute the gamma prime strengthening phase, which depending on the needs of a given application may be stabilized by tantalum. Thus, in this case, aluminum, tungsten or tantalum may be non-limiting examples of gamma prime constituents that may be used with the reduced concentration to provide the desired level of ductility appropriate for the drawing of the elongated core member.

In another non-limiting example, the strengthening constituent may be a gamma double prime constituent. In the case of a nickel-base superalloy, Ni₃Nb may constitute the gamma double prime strengthening phase. Thus, in this case, niobium may be a non-limiting example of a gamma double prime constituent that may be used with the reduced concentration to provide the desired level of ductility appropriate for the drawing of the elongated core member.

Step 12 allows applying a coating 22 to elongated core member 20, which in combination form a welding material 24 that without limitation may be used as a consumable electrode or weld filler material. The coating is configured to introduce a sufficient concentration of the strengthening constituent to form the desired superalloy composition when melting together coating 22 and elongated core member 20 to form the desired superalloy composition (step 14 in FIG. 1). That is, during the welding process, welding material 24 may form a localized weld pool 26 prior to solidification.

In one non-limiting embodiment, coating 22 may be configured so that the concentration of the strengthening constituent introduced by coating 22 is adjusted (e.g., incremented) for volatilization of the strengthening constituent that may occur upon deposition of the superalloy composition. It should be appreciated that ductile materials are sometimes applied to rods for enhanced lubrication during the drawing process. Aluminum is one example of a ductile material that is also a gamma prime constituent. In such case the coating step (of e.g. ductile aluminum) could be applied to a rod of the core member of reduced gamma prime constituent before or while drawing the coated rod into wire form.

Non limiting examples of superalloy compositions that may benefit from disclosed embodiments may include alloys sold under the trademarks and brand names Hastelloy, Inconel alloys (e.g. IN 738, IN 792, IN 939), Rene alloys (e.g. Rene N5, Rene 80, Rene 142), Haynes alloys, Mar M, CM 247, CM 247 LC, C263, 718, X-750, ECY 768, 282, X40, X45, PWA 1483 and CMSX (e.g. CMSX-4) single crystal alloys.

Let us presume a 1.59 mm ( 1/16 inch) diameter for elongated core member 20 (e.g., a wire). Let us further presume applying a coating 22 of pure aluminum to obtain a three weight percent aluminum in the deposit of the desired superalloy composition. Then, it can be shown using straightforward calculations (e.g., volumetric relationships) that in this non-limiting example the coating thickness would be about 0.078 mm. Similarly, if one desired a five weight percent aluminum in the deposit of the desired superalloy composition, then the coating thickness in this case would be about 0.134 mm.

Thus, for a typical application, such as described in the context of the foregoing non-limiting example, the coating may be configured to introduce a concentration of the strengthening constituent in a range from approximately three weight percent of the strengthening constituent in the deposit of the desired superalloy composition to approximately five weight percent of the strengthening constituent in the deposit of the desired superalloy composition. This would constitute a sufficient concentration of the strengthening constituent to form the desired superalloy composition when the coating and the elongated core member are melted together. In general, the coating is configured to introduce a mass (e.g., coating volume times constituent density) of the strengthening constituent to provide, after any volatile welding transfer losses, the desired weight percent of the strengthening constituent in the deposited weld metal.

It will be appreciated by one skilled in the art, that an element like titanium, which is denser than aluminum would involve a thinner coating thickness to achieve the foregoing weight percentages for the deposit of the desired superalloy composition. Accordingly, in this non-limiting example, for a typical weld wire diameter, a range from approximately 0.02 mm to approximately 0.2 mm for the coating thickness would allow introducing a sufficient concentration of strengthening constituents, such as Al or Ti, to form the desired superalloy composition. It will be appreciated that the foregoing example should be construed in a non-limiting sense since it should be appreciated that the coating may be readily tailored based on the needs of a given application.

In operation, disclosed methods are conducive to cost-effective production of superalloy weld wire. This is realized by way of imparting improved drawability to an elongated core member configured with reduced material strength and improved ductility. This in turn is conducive to cost-effective wire welding of superalloy components, such as superalloy blades and vanes in a gas turbine engine. This welding may be performed in the context of repairing, rebuilding, and manufacturing such components.

While embodiments of the present disclosure have been disclosed in exemplary forms, it will be apparent to those skilled in the art that many modifications, additions, and deletions can be made therein without departing from the scope of the invention and its equivalents, as set forth in the following claims.

What is claimed is:

1. A method for depositing a desired superalloy composition, the method comprising:
drawing an elongated core member comprising a wrought nickel-base alloy or a wrought cobalt-base alloy, the elongated core member comprising at least one strengthening constituent having a reduced concentration to provide a desired level of ductility appropriate for the drawing of the elongated core member; and
applying a coating to the elongated core member, the coating introducing a sufficient concentration of said at least one strengthening constituent to form the desired superalloy composition when the coating and the elongated core member are melted together.

2. The method of claim 1, wherein the at least one strengthening constituent is a gamma prime constituent.

3. The method of claim 2, wherein the at least one gamma prime strengthening constituent is titanium, and the reduced concentration is in range from zero percent by weight to two percent by weight relative to a total weight of the elongated core member.

4. The method of claim 2, wherein the at least one gamma prime strengthening constituent is aluminum and the reduced concentration in the elongated core member is in range from zero percent by weight to two percent by weight relative to a total weight of the elongated core member.

5. The method of claim 2, wherein for the cobalt-base alloy the at least one gamma prime strengthening constituent is tungsten, and the reduced concentration is in range from zero percent by weight to two percent by weight relative to a total weight of the elongated core member.

6. The method of claim 2, wherein for the cobalt-base alloy the at least one gamma prime strengthening constituent is tantalum, and the reduced concentration is in range from zero percent by weight to two percent by weight relative to a total weight of the elongated core member.

7. The method of claim 1, wherein the at least one strengthening constituent is a gamma double prime constituent.

8. The method of claim 7, wherein the at least one gamma double prime strengthening constituent is Niobium and the reduced concentration in the elongated core member is in range from zero percent by weight to two percent by weight relative to a total weight of the elongated core member.

9. The method of claim 1, wherein the elongated core member comprises a wire.

10. The method of claim 1, wherein the elongated core member comprises a strip.

11. The method of claim 1, wherein the desired level of ductility of the elongated core member is in a range from 10 percent elongation to 45% elongation.

12. The method of claim 1, wherein the coating and elongated core member are melted during a welding process.

13. The method of claim 1, further comprising incrementing the concentration introduced by the coating of said at least one strengthening constituent to compensate for volatilization of said at least one strengthening constituent.

14. The method of claim 1, wherein the coating step is performed on a rod form of the elongated core member prior to or concurrent with the drawing step, and wherein the drawing step comprises drawing to a wire form either a coated rod form of the elongated core member; or the rod form of the elongated core member while being coated.

15. A method for depositing a desired superalloy composition, the method comprising:
melting a welding material during a welding process conducive to depositing the desired superalloy composition, wherein:
the welding material is formed by an elongated core member comprising a wrought nickel base alloy or a wrought cobalt base alloy, the elongated core member comprising at least one strengthening constituent having a reduced concentration and thus providing an increased level of ductility to the elongated core member; and
a coating on the elongated core, the coating configured to introduce a sufficient concentration of said at least one strengthening constituent to form the desired superalloy composition upon the melting of the coating and the elongated core member that form the welding material.

16. The method of claim 15, wherein the welding material comprises a consumable electrode.

17. The method of claim 15, wherein the welding material comprises a weld filler material.

18. The method of claim 15, wherein, the increased level of ductility provided to the elongated core member by the reduced concentration of the at least one strengthening constituent is effective for performing a drawing process in connection with the elongated core member prior to applying the coating on the elongated core.

19. The method of claim 15, wherein the at least one strengthening constituent is a gamma prime constituent selected from the group consisting of titanium, aluminum, tungsten, and tantalum, and wherein the reduced concentration of the at least one strengthening constituent is in range from zero percent by weight to two percent by weight relative to a total weight of the elongated core member.

20. The method of claim 15, wherein the at least one strengthening constituent is a gamma double prime constituent comprising Niobium, and the reduced concentration of the at least one strengthening constituent is in range from zero percent by weight to two percent by weight relative to a total weight of the elongated core member
